(19) United States
(12) Patent Application Publication
(10) Pub. No.: US 2025/0373379 A1
(43) Pub. Date: Dec. 4, 2025

(54) CONFIGURING AN UPLINK BANDWIDTH PART AND A DOWNLINK BANDWIDTH PART

(71) Applicant: Lenovo (Singapore) Pte. Ltd., Singapore (SG)

(72) Inventors: Colin Frank, Park Ridge, IL (US); John R. Mura, Clarendon Hills, IL (US); Armin W. Klomsdorf, Chicago, IL (US)

(21) Appl. No.: 18/877,094

(22) PCT Filed: Jun. 20, 2023
(86) PCT No.: PCT/IB2023/056388

§ 371 Date: Dec. 19, 2024

Related U.S. Application Data
(60) Provisional application No. 63/353,718, filed on Jun. 20, 2022.

(51) Int. Cl. H04L 5/00; H04L 27/26; H04W 52/36

(52) U.S. Cl. CPC H04L 5/0044; H04L 5/0098; H04L 27/2656; H04W 52/367

(57) ABSTRACT

Apparatuses, methods, and systems are disclosed for configuring an uplink bandwidth part (BWP) and a downlink BWP. One method includes configuring, at a communication device, a downlink BWP for a time division duplex band. The method includes configuring an uplink BWP for the time division duplex band. The uplink BWP is different from the downlink BWP.

### FIELD

The subject matter disclosed herein relates generally to wireless communications and more particularly relates to configuring an uplink bandwidth part (BWP) and a downlink BWP.

### BACKGROUND

In certain wireless communications networks, BWPs may be used. In such networks, the BWPs may operate using different parameters.

### BRIEF SUMMARY

Methods for configuring an uplink BWP and a downlink BWP are disclosed. Apparatuses and systems also perform the functions of the methods. One embodiment of a method includes configuring, at a communication device, a downlink BWP for a time division duplex band. In some embodiments, the method includes configuring an uplink BWP for the time division duplex band. The uplink BWP is different from the downlink BWP.

One apparatus for configuring an uplink BWP and a downlink BWP includes a processor to: configure a downlink BWP for a time division duplex band: and configure an uplink BWP for the time division duplex band. The uplink BWP is different from the downlink BWP.

Another method for configuring an uplink BWP and a downlink BWP includes receiving, at a communication device, data on an uplink BWP. The uplink BWP is configured for a time division duplex band, a downlink BWP is configured for the time division duplex band, and the uplink BWP is different from the downlink BWP.

Another apparatus for configuring an uplink BWP and a downlink BWP includes a receiver to receive data on an uplink BWP. The uplink BWP is configured for a time division duplex band, a downlink BWP is configured for the time division duplex band, and the uplink BWP is different from the downlink BWP.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring an uplink BWP and a downlink BWP:

FIG. 2 is a schematic block diagram illustrating one embodiment of an apparatus that may be used for configuring an uplink BWP and a downlink BWP:

FIG. 3 is a schematic block diagram illustrating one embodiment of an apparatus that may be used for configuring an uplink BWP and a downlink BWP:

FIG. 4 is a schematic block diagram illustrating one embodiment of a system 400 for positioning a common local oscillator (LO) location for uplink and downlink:

FIG. 5 is a flow chart diagram illustrating one embodiment of a method for configuring an uplink BWP and a downlink BWP: and

FIG. 6 is a flow chart diagram illustrating another embodiment of a method for configuring an uplink BWP and a downlink BWP.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM” or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

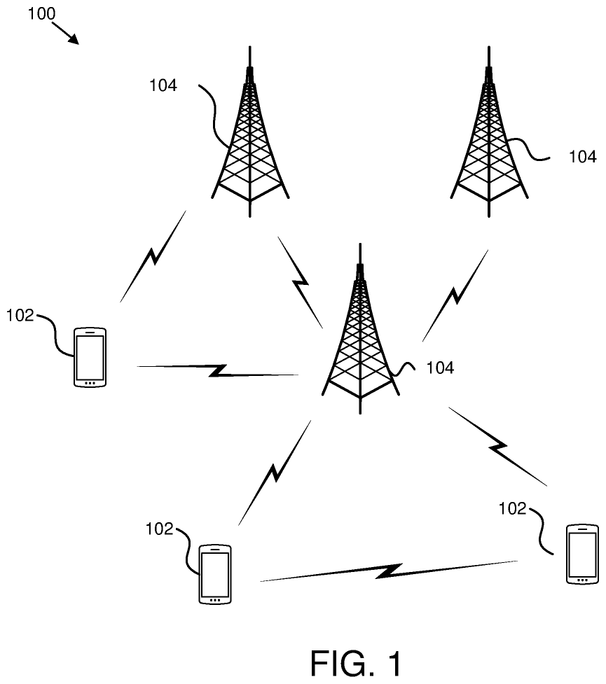

FIG. 1 depicts an embodiment of a wireless communication system 100 for configuring an uplink BWP and a downlink BWP. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (CN), a radio network entity, a Node-B, an evolved node-B (eNB), a 5G node-B (gNB), a Home Node-B, a relay node, a device, a core network, an aerial server, a radio access node, an access point (AP), new radio (NR), a network entity, an access and mobility management function (AMF), a unified data management (UDM), a unified data repository (UDR), a UDM/UDR, a policy control function (PCF), a radio access network (RAN), a network slice selection function (NSSF), an operations, administration, and management (OAM), a session management function (SMF), a user plane function (UPF), an application function, an authentication server function (AUSF), security anchor functionality (SEAF), trusted non-third generation partnership project (3GPP) gateway function (TNGF), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (OFDM) modulation scheme on the downlink (DL) and the remote units 102 transmit on the uplink (UL) using a single-carrier frequency division multiple access (SC-FDMA) scheme or an OFDM scheme. More generally, however, the wireless communication system 100 may implement some other open or proprietary communication protocol, for example, WiMAX, institute of electrical and electronics engineers (IEEE) 802.11 variants, global system for mobile communications (GSM), general packet radio service (GPRS), universal mobile telecommunications system (UMTS), long term evolution (LTE) variants, code division multiple access 2000 (CDMA2000), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may configure, at a communication device, a downlink BWP for a time division duplex band. In some embodiments, the remote unit 102 and/or the network unit 104 may configure an uplink BWP for the time division duplex band. The uplink BWP is different from the downlink BWP. Accordingly, the remote unit 102 and/or the network unit 104 may be used for configuring an uplink BWP and a downlink BWP.

In certain embodiments, a remote unit 102 and/or a network unit 104 may receive, at a communication device, data on an uplink BWP. The uplink BWP is configured for a time division duplex band, a downlink BWP is configured for the time division duplex band, and the uplink BWP is different from the downlink BWP. Accordingly, the remote unit 102 and/or the network unit 104 may be used for configuring an uplink BWP and a downlink BWP.

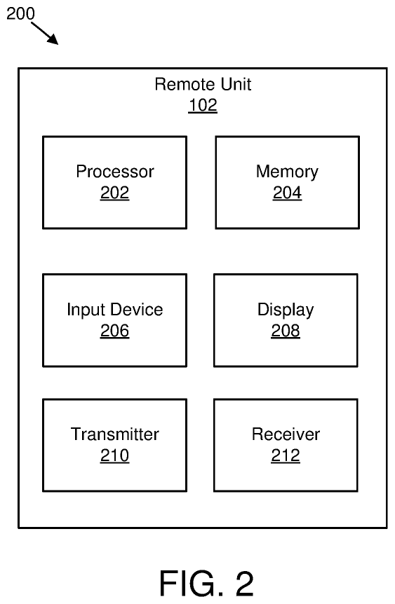

FIG. 2 depicts one embodiment of an apparatus 200 that may be used for configuring an uplink BWP and a downlink BWP. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (LCD), a light emitting diode (LED) display, an organic light emitting diode (OLED) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 may: configure a downlink BWP for a time division duplex band: and configure an uplink BWP for the time division duplex band. The uplink BWP is different from the downlink BWP.

In some embodiments, the receiver 212 may receive data on an uplink BWP. The uplink BWP is configured for a time division duplex band, a downlink BWP is configured for the time division duplex band, and the uplink BWP is different from the downlink BWP.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

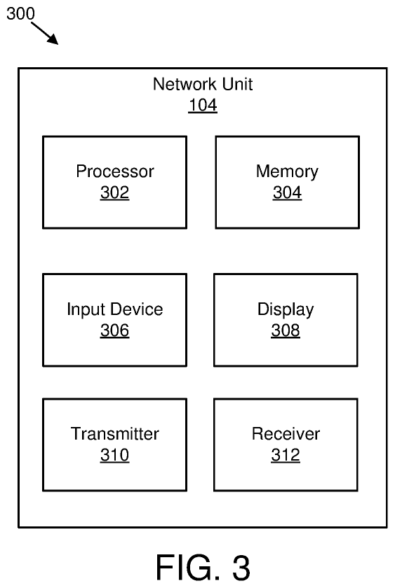

FIG. 3 depicts one embodiment of an apparatus 300 that may be used for configuring an uplink BWP and a downlink BWP. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 may: configure a downlink BWP for a time division duplex band; and configure an uplink BWP for the time division duplex band. The uplink BWP is different from the downlink BWP.

In some embodiments, the receiver 312 may receive data on an uplink BWP. The uplink BWP is configured for a time division duplex band, a downlink BWP is configured for the time division duplex band, and the uplink BWP is different from the downlink BWP.

It should be noted that one or more embodiments described herein may be combined into a single embodiment.

In certain embodiments, a user equipment (UE) needs capability signaling to indicate that it can place its LO at a frequency location requested by a gNB or to indicate that the UE can meet additional emissions requirements.

In some embodiments, a UE may select a transmitter filter bandwidth smaller than a carrier bandwidth to reduce emissions and to enable the UE to meet emissions requirements with reduced maximum power reduction (MPR). In some embodiments, a UE may select a transmitter filter bandwidth smaller than a carrier bandwidth to reduce emissions and to enable the UE to meet additional emissions requirements with reduced additional maximum power reduction (A-MPR).

In various embodiments, when switching from one BWP to another, a UE needs time to move a location of a LO from one frequency to another. Similarly, if the UE decides to change the bandwidth or the center frequency of the transmitter filter or of the receiver filter, the UE will require time to complete this operation also. The UE may need to change a sampling rate of a transmitter and/or receiver in order to reduce power consumption. In certain embodiments, a BWP switching delay may be implemented as shown in Table 1. In Table 1, the BWP switch delay depends on the UE capability signaling.

TABLE 1
BWP Switch Delay

| | |
|---|---|
| NR Slot | BWP Switch Delay |
| Length | T_{BWPswitchDelay} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of subcarrier spacing (SCS), the BWP switch delay is determined by the smaller SCS between the SCS before BWP switch and the SCS after BWP switch.

In some embodiments, a UE is allowed to choose a frequency location of a LO for a BWP and must report the location of the LO if it is other than a default location. As a result, the UE may choose not to move the LO location and report a Type 1 capability. In various embodiments, if a UE indicates a capability to move a LO to a location signaled by a gNB, and if the gNB directs the UE to move its LO to a specified location during activation of a BWP, then the UE may require a larger switching delay. For example, the UE signals that it is Type 1 if it is not required to move its LO, but Type 2 if it is required to move its LO. Alternatively, switch delays other than those in Table 1 may be defined, with a first switch delay defined for the case of no additional requirements, and a second longer switch delay defined in the case that additional requirements are applied. Furthermore, multiple switch delays may be defined with each corresponding to a different set of additional requirements.

In certain embodiments, there is no requirement on a transmitter filter bandwidth used by a UE other than that the UE meets emission requirements. The UE may use the same transmitter filter bandwidth for a BWP as is used for a full carrier bandwidth. However, the UE may on its own choose a smaller bandwidth filter and adjust it center frequency to reduce emissions into adjacent carriers or bands or into the UE's receive spectrum. In some embodiments, a UE may indicate to a gNB that it has the ability to change a bandwidth and center frequency of the transmitter filter if requested. In such embodiments, if the gNB requests that the UE change the bandwidth or the center frequency of its transmitter filter, then the UE may require a different and possibly larger switching delay than in Table 1. In various embodiments, a UE may indicate that it is a Type 2 UE if it is required to change the bandwidth or center frequency of its transmitter filter, but otherwise indicate that it is a Type 1 UE.

In some embodiments, such as for time domain duplexing (TDD) bands, there is a requirement that a same BWP identifier (ID) be used for both uplink and the downlink. Additionally, in such embodiments, it is required that an LO location be the same for the uplink BWP and the downlink BWP. In various embodiments, there may be no signaling available to indicate if LO locations for a transmitter and a receiver are different. However, while BWP ID's and LO locations are the same for the uplink transmitter and downlink receiver, the BWPs themselves can be different. Thus, it may be that a smaller BWP is used for uplink while a larger BWP is used for downlink. Accordingly, the UE may use the same bandwidth for the transmitter filter as for the receiver filter or may use a different bandwidth and center frequency for the transmitter filter than for the receiver filter.

In some cases, the uplink and downlink data rate requirements may be asymmetric. If the data rate requirements are less for uplink than for downlink, then the bandwidth of the BWP for the uplink may be much smaller than the bandwidth of the BWP for the downlink. However, in some cases, the data rate requirement for uplink may be equal to or greater than the data rate requirement for downlink, in which case the bandwidth of an uplink BWP may be greater than or equal to the bandwidth of a downlink BWP. For this reason, different uplink BWPs may be combined with the same downlink BWP.

While there is a requirement that the BWP ID for uplink is the same as the BWP ID for downlink, there is still an ability to pair the same downlink BWP with different uplink BWPs, and similarly, to pair the same uplink BWP with more than one downlink BWP. To pair a downlink BWP with more than one uplink BWP, the downlink BWP can be assigned multiple BWP IDs where each of these IDs corresponds to the ID of an uplink BWP to be paired with the downlink BWP. Similarly, an uplink BWP can be assigned multiple BWP IDs where each of these IDs corresponds to an ID of a downlink BWP to be paired with the uplink BWP.

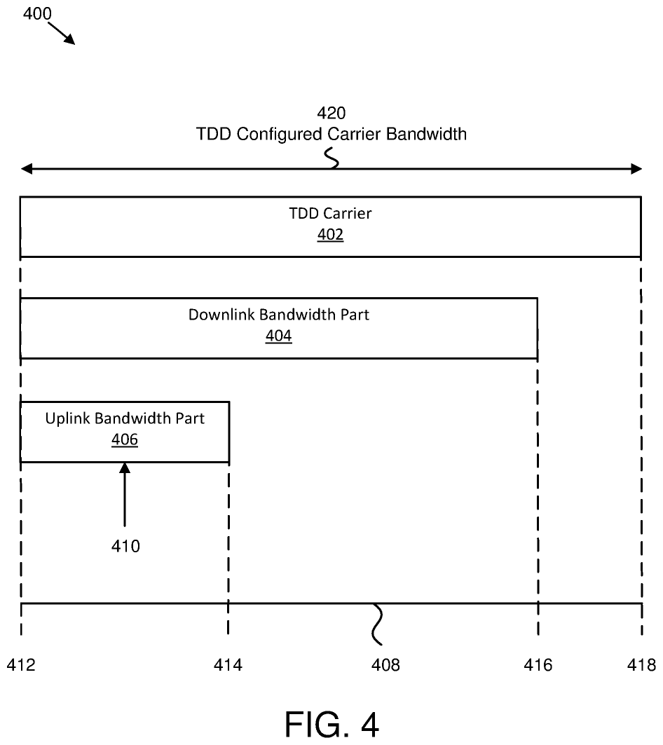

In certain embodiments, if emissions into adjacent carriers or adjacent bands are a concern, the frequency of a common LO location for the uplink and downlink BWPs may be centered within an uplink BWP to reduce a frequency span of intermodulation products generated by a power amplifier and other transmitter nonlinearities. An example is given in FIG. 4. Further, it may make sense to use a smaller bandwidth baseband transmit filter for an uplink BWP than baseband receive filter for a downlink BWP if the bandwidth of the uplink BWP is smaller than the bandwidth of the downlink BWP. By using a smaller BWP for uplink, centering the frequency of the LO within the uplink BWP, and using a smaller bandwidth transmit filter, the MPR, and A-MPR needed to meet emissions constraints and network signaled (NS) additional emissions constraints can be reduced.

As an example of a TDD band for which A-MPR can be reduced by using BWPs, there may be a case of band n39 when NS_50 is signaled by the network. It should be noted that band n39 covers the frequency range of 1880 to 1920 MHz and thus has a bandwidth of 40 MHz. When NS_50 is signaled, the following requirements from Table 2 apply.

TABLE 2
Additional requirements for “NS_50”

| | Frequency | | | Maximum | MBW | |
|---|---|---|---|---|---|---|
| Protected band | range (MHz) | | | Level (dBm) | (MHz) | NOTE |
| Frequency range | 1805 | — | 1855 | −40 | 1 | 1 |
| Frequency range | 1855 | — | 1880 | −15.5 | 5 | 1, 2, 3 |

The corresponding A-MPR that is allowed is captured in Tables 3 and 4.

TABLE 3
A-MPR regions for NS_50 (Power Class 3)

| Channel | | | |
|---|---|---|---|
| Bandwidth | RBₛₜₐᵣₜ*12*SCS | L_{CRB}*12*SCS | |
| (MHz) | (MHz) | (MHz) | A-MPR |
| 25 MHz | ≤L_{CRB}*12*SCS − 5 | >5 | A7 |
| | ≤20 | ≤1.44 | A8 |
| 30 MHz | ≤L_{CRB}*12*SCS − 5 | >5 | A7 |
| | ≤25 | ≤1.44 | A8 |
| | | ≤3.6 | A9 |
| 40 MHz | ≤4.32 | >0 | A1 |
| | >4.32, ≤10.44 | ≤10.8 | A3 |
| | >4.32, ≤18 | >10.8 | A2 |
| | >18, ≤31.68 | >max (31.68 − | A6 |
| | | RBₛₜₐᵣₜ*12*SCS, 0) | |
| | >31.68 | >0 | A5 |

NOTE 1:
The A-MPR values are specified in Table 6.2.3.19-2.

TABLE 4
A-MPR for NS_50 (Power Class 3)

| | | | A1 (dB) | A2 (dB) | A3 (dB) | A5 (dB) | A6 (dB) | A7 (dB) | A8 (dB) |
|---|---|---|---|---|---|---|---|---|---|
| Modulation/Waveform | | | Outer/Inner | Outer/Inner | Outer/Inner | Outer/Inner | Outer/Inner | Outer/Inner | Outer/Inner |
| DFT-s- | Pi/2 | | ≤11 | ≤7 | ≤3 | ≤5 | ≤2 | ≤4 | ≤2 |
| OFDM | BPSK | | | | | | | | |
| | QPSK | | ≤11 | ≤7 | ≤3 | ≤5 | ≤2 | ≤5 | ≤2 |
| | 16 | QAM | ≤11 | ≤7 | ≤3 | ≤5 | ≤2 | ≤5 | ≤2.5 |
| | 64 | QAM | ≤11 | ≤7 | ≤3 | ≤5 | | ≤5 | |
| | 256 | QAM | ≤11 | ≤7 | | ≤5 | | ≤5 | |
| CP- | QPSK | | ≤12 | ≤8 | ≤4.5 | ≤5 | ≤3.5 | ≤6.5 | |
| OFDM | 16 | QAM | ≤12 | ≤8 | ≤4.5 | ≤5 | ≤3.5 | ≤6.5 | |
| | 64 | QAM | ≤12 | ≤8 | ≤4.5 | ≤5 | | ≤6.5 | |
| | 256 | QAM | ≤12 | ≤8 | | | | ≤6.5 | |

From Tables 3 and 4, it can be observed that the A-MPR allowed for a 40 MHz carrier can be as large as 12 dB for the A1 region and as large as 8 dB for the A2 region. However, it can be observed that since the case of a 20 MHz carrier is not included in Table 3, no A-MPR is allowed for a 20 MHz regardless of the placement of the carrier within the band and regardless of the RB allocation. Thus, if a 40 MHz downlink BWP is paired with a 20 MHz uplink BWP, and if the frequency of the LO is centered within the uplink BWP and the same baseband transmit filter is used for the 20 MHz uplink BWP as for a 20 MHz carrier, then no A-MPR is needed or allowed for the 20 MHz BWP. Thus, by using BWPs in this fashion for a TDD band, the A-MPR that is needed can be greatly reduced or eliminated.

FIG. 4 is a schematic block diagram illustrating one embodiment of a system 400 for positioning a common LO location for uplink and downlink. The system 400 includes a TDD carrier 402, a downlink BWP 404, and an uplink BWP 406 over a frequency 408. A common LO location 410 (e.g., the center of the uplink BWP 406) may be used for uplink and downlink. The TDD carrier 402, the downlink BWP 404, and the uplink BWP 406 all have the same starting frequency 412, but have different ending frequencies 414, 416, and 418, respectively. The TDD carrier 402 has a TDD configured carrier bandwidth 420.

In some embodiments, a UE may indicate a different BWP switching time capability (e.g., Type 1 or Type 2) if the UE indicates it has the capability to change a common LO location for uplink and downlink BWPs from a default LO location and a gNB indicates that the UE should use a different location than a default location. Similarly, a UE may indicate a different BWP switching time capability if the UE indicates a capability to use a different center frequency and filter bandwidth for the uplink BWP transmitter than for the downlink BWP receiver and the gNB indicates that the UE should use a different bandwidth transmitter filter than the default bandwidth (e.g., the carrier bandwidth). In various embodiments, a required switching time for moving an LO location and or changing a bandwidth and center frequency of the transmitter filter may require a BWP switching time different than and possibly larger than any of the switching times indicated in Table 1.

In certain embodiments, additional implementation issues may affect a required BWP switching time. Such issues may include whether allowed bandwidths of a transmitter filter are limited to those corresponding to allowed carrier bandwidths or may include other bandwidths. The BWP switching time may also depend on whether or not a sampling rate of a digital-to-analog converter is reduced proportionally to a ratio of a bandwidth of a BWP to a carrier bandwidth, in which case it may be possible to use the same transmitter filter coefficients as for the full carrier bandwidth. Depending on these implementation details, the BWP switching time may be different than and possibly larger than times indicated in Table 1.

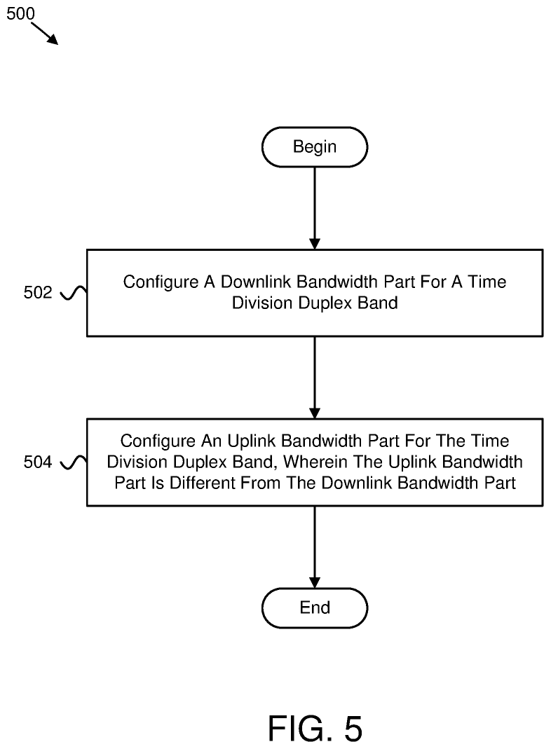

FIG. 5 is a flow chart diagram illustrating one embodiment of a method 500 for configuring an uplink BWP and a downlink BWP. In some embodiments, the method 500 is performed by an apparatus, such as the remote unit 102 and/or the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes configuring 502, at a communication device, a downlink BWP for a time division duplex band. In some embodiments, the method 500 includes configuring 504 an uplink BWP for the time division duplex band. The uplink BWP is different from the downlink BWP.

In certain embodiments, the method 500 further comprises configuring a frequency of a common local oscillator (LO) for the uplink BWP and the downlink BWP at a center of the uplink BWP. In some embodiments, the method 500 further comprises configuring a baseband transmit filter such that the baseband transmit filter contains the uplink BWP and a bandwidth of the baseband transmit filter is less than a carrier bandwidth. In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP. In certain embodiments, a maximum power reduction (MPR) allowed to meet emissions requirements is a reduced MPR relative to the MPR that is allowed if no BWP is configured for uplink. In some embodiments, an MPR allowed to meet emissions constraints is the MPR allowed for the carrier bandwidth larger than a bandwidth of the uplink BWP but smaller than the carrier bandwidth.

In various embodiments, an MPR allowed to meet emissions constraints is the MPR for a smallest carrier bandwidth larger than a bandwidth of the uplink BWP. In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for the carrier bandwidth larger than a bandwidth of the uplink BWP but smaller than the carrier bandwidth. In some embodiments, an A-MPR allowed to meet additional emissions constraints is the A-MPR for a smallest carrier bandwidth larger than a bandwidth of the uplink BWP.

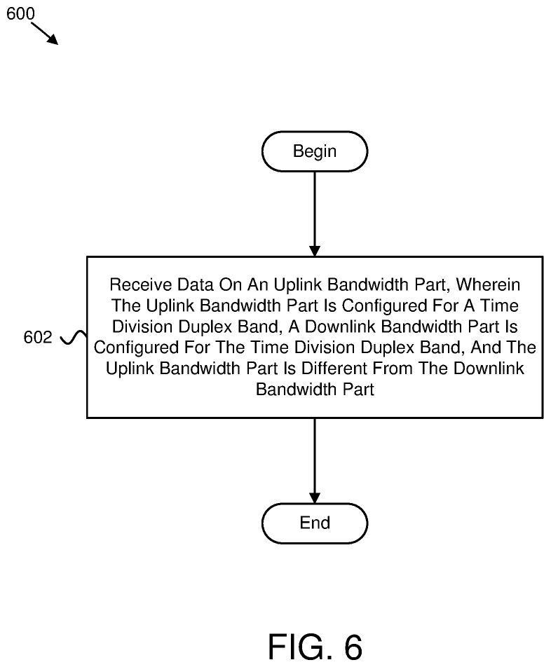

FIG. 6 is a flow chart diagram illustrating another embodiment of a method 600 for configuring an uplink BWP and a downlink BWP. In some embodiments, the method 600 is performed by an apparatus, such as the remote unit 102 and/or the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602, at a communication device, data on an uplink BWP. The uplink BWP is configured for a time division duplex band, a downlink BWP is configured for the time division duplex band, and the uplink BWP is different from the downlink BWP.

In certain embodiments, a frequency of a common local oscillator (LO) is configured for the uplink BWP and the downlink BWP at a center of the uplink BWP. In some embodiments, a baseband transmit filter is configured such that the baseband transmit filter contains the uplink BWP and a bandwidth of the baseband transmit filter is less than a carrier bandwidth. In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP. In certain embodiments, a maximum power reduction (MPR) allowed to meet emissions requirements is a reduced MPR relative to the MPR that is allowed if no BWP is configured for uplink. In some embodiments, an MPR allowed to meet emissions constraints is the MPR allowed for a carrier bandwidth larger than a bandwidth of the uplink BWP but smaller than the configured carrier bandwidth.

In various embodiments, an MPR allowed to meet emissions constraints is the MPR for a smallest carrier bandwidth larger than a bandwidth of the uplink BWP. In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for a carrier bandwidth larger than a bandwidth of the uplink BWP but smaller than the configured carrier bandwidth. In some embodiments, an A-MPR allowed to meet additional emissions constraints is the A-MPR for a smallest carrier bandwidth larger than a bandwidth of the uplink BWP.

In one embodiment, an apparatus comprises: a processor to: configure a downlink BWP for a time division duplex band; and configure an uplink BWP for the time division duplex band, wherein the uplink BWP is different from the downlink BWP.

In certain embodiments, the processor configures a frequency of a common local oscillator (LO) for the uplink BWP and the downlink BWP at a center of the uplink BWP.

In some embodiments, the processor configures a baseband transmit filter such that the baseband transmit filter contains the uplink BWP and a bandwidth of the baseband transmit filter is less than a carrier bandwidth.

In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP.

In certain embodiments, a maximum power reduction (MPR) allowed to meet emissions requirements is a reduced MPR relative to the MPR that is allowed if no BWP is configured for uplink.

In some embodiments, an MPR allowed to meet emissions constraints is the MPR allowed for a carrier bandwidth larger than a bandwidth of the uplink BWP but smaller than the configured carrier bandwidth.

In various embodiments, an MPR allowed to meet emissions constraints is the MPR for a smallest carrier bandwidth larger than a bandwidth of the uplink BWP.

In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for a carrier bandwidth larger than a bandwidth of the uplink BWP but smaller than the configured carrier bandwidth.

In some embodiments, an A-MPR allowed to meet additional emissions constraints is the A-MPR for a smallest carrier bandwidth larger than a bandwidth of the uplink BWP.

In one embodiment, a method of a communication device comprises: configuring a downlink BWP for a time division duplex band; and configuring an uplink BWP for the time division duplex band, wherein the uplink BWP is different from the downlink BWP.

In certain embodiments, the method further comprises configuring a frequency of a common local oscillator (LO) for the uplink BWP and the downlink BWP at a center of the uplink BWP.

In some embodiments, the method further comprises configuring a baseband transmit filter such that the baseband transmit filter contains the uplink BWP and a bandwidth of the baseband transmit filter is less than a carrier bandwidth.

In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP.

In certain embodiments, a maximum power reduction (MPR) allowed to meet emissions requirements is a reduced MPR relative to the MPR that is allowed if no BWP is configured for uplink.

In some embodiments, an MPR allowed to meet emissions constraints is the MPR allowed for a carrier bandwidth larger than a bandwidth of the uplink BWP but smaller than the configured carrier bandwidth.

In various embodiments, an MPR allowed to meet emissions constraints is the MPR for a smallest carrier bandwidth larger than a bandwidth of the uplink BWP.

In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for a carrier bandwidth larger than a bandwidth of the uplink BWP but smaller than the configured carrier bandwidth.

In some embodiments, an A-MPR allowed to meet additional emissions constraints is the A-MPR for a smallest carrier bandwidth larger than a bandwidth of the uplink BWP.

In one embodiment, an apparatus comprises a receiver to receive data on an uplink BWP, wherein the uplink BWP is configured for a time division duplex band, a downlink BWP is configured for the time division duplex band, and the uplink BWP is different from the downlink BWP.

In certain embodiments, a frequency of a common local oscillator (LO) is configured for the uplink BWP and the downlink BWP at a center of the uplink BWP.

In some embodiments, a baseband transmit filter is configured such that the baseband transmit filter contains the uplink BWP and a bandwidth of the baseband transmit filter is less than a carrier bandwidth.

In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP.

In certain embodiments, a maximum power reduction (MPR) allowed to meet emissions requirements is a reduced MPR relative to the MPR that is allowed if no BWP is configured for uplink.

In some embodiments, an MPR allowed to meet emissions constraints is the MPR allowed for a carrier bandwidth larger than a bandwidth of the uplink BWP but smaller than the configured carrier bandwidth.

In various embodiments, an MPR allowed to meet emissions constraints is the MPR for a smallest carrier bandwidth larger than a bandwidth of the uplink BWP.

In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for a carrier bandwidth larger than a bandwidth of the uplink BWP but smaller than the configured carrier bandwidth.

In some embodiments, an A-MPR allowed to meet additional emissions constraints is the A-MPR for a smallest carrier bandwidth larger than a bandwidth of the uplink BWP.

In one embodiment, a method of a communication device comprises receiving data on an uplink BWP, wherein the uplink BWP is configured for a time division duplex band, a downlink BWP is configured for the time division duplex band, and the uplink BWP is different from the downlink BWP.

In certain embodiments, a frequency of a common local oscillator (LO) is configured for the uplink BWP and the downlink BWP at a center of the uplink BWP.

In some embodiments, a baseband transmit filter is configured such that the baseband transmit filter contains the uplink BWP and a bandwidth of the baseband transmit filter is less than a carrier bandwidth.

In various embodiments, the bandwidth of the baseband transmit filter corresponds to a bandwidth of an allowed carrier bandwidth for a given frequency band.

In one embodiment, the bandwidth of the baseband transmit filter corresponds to a bandwidth of a smallest allowed carrier bandwidth for the given frequency band larger than a bandwidth of the uplink BWP.

In certain embodiments, a maximum power reduction (MPR) allowed to meet emissions requirements is a reduced MPR relative to the MPR that is allowed if no BWP is configured for uplink.

In some embodiments, an MPR allowed to meet emissions constraints is the MPR allowed for a carrier bandwidth larger than a bandwidth of the uplink BWP but smaller than the configured carrier bandwidth.

In various embodiments, an MPR allowed to meet emissions constraints is the MPR for a smallest carrier bandwidth larger than a bandwidth of the uplink BWP.

In one embodiment, an additional MPR (A-MPR) allowed to meet additional emissions requirements is a reduced A-MPR relative to the A-MPR that is allowed if no BWP is configured for uplink.

In certain embodiments, an A-MPR allowed to meet additional emissions constraints is the A-MPR allowed for a carrier bandwidth larger than a bandwidth of the uplink BWP but smaller than the configured carrier bandwidth.

In some embodiments, an A-MPR allowed to meet additional emissions constraints is the A-MPR for a smallest carrier bandwidth larger than a bandwidth of the uplink BWP.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
configure a downlink bandwidth part (BWP) for a time division duplex band; and
configure an uplink BWP for the time division duplex band, wherein the uplink BWP is different from the downlink BWP.

2. The UE of claim 1, wherein the at least one processor is configured to cause the UE to configure a frequency of a common local oscillator (LO) for the uplink BWP and the downlink BWP at a center of the uplink BWP.

3. The UE of claim 1, wherein the at least one processor is configured to cause the UE to configure a baseband transmit filter such that the baseband transmit filter contains the uplink BWP and a bandwidth of the baseband transmit filter is less than a carrier bandwidth.

4. The UE of claim 3, wherein the bandwidth of the baseband transmit filter corresponds to a bandwidth of an allowed carrier bandwidth for a given frequency band.

5. The UE of claim 4, wherein the bandwidth of the baseband transmit filter corresponds to a bandwidth of a smallest allowed carrier bandwidth for the given frequency band larger than a bandwidth of the uplink BWP.

6. The UE of claim 3, wherein a maximum power reduction (MPR) allowed to meet emissions requirements is a reduced MPR relative to the MPR that is allowed if no BWP is configured for uplink.

7. The UE of claim 3, wherein a maximum power reduction (MPR) allowed to meet emissions constraints is the MPR allowed for a carrier bandwidth larger than a bandwidth of the uplink BWP but smaller than the configured carrier bandwidth.

8. The UE of claim 3, wherein a maximum power reduction (MPR) allowed to meet emissions constraints is the MPR for a smallest carrier bandwidth larger than a bandwidth of the uplink BWP.

9. The UE of claim 3, wherein an additional MPR (A-MPR) allowed to meet additional emissions requirements is a reduced A-MPR relative to the A-MPR that is allowed if no BWP is configured for uplink.

10. The UE of claim 3, wherein an additional MPR (A-MPR) allowed to meet additional emissions constraints is the A-MPR allowed for a carrier bandwidth larger than a bandwidth of the uplink BWP but smaller than the configured carrier bandwidth.

11. The UE of claim 3, wherein an additional MPR (A-MPR) allowed to meet additional emissions constraints is the A-MPR for a smallest carrier bandwidth larger than a bandwidth of the uplink BWP.

12. A user equipment (UE), comprising:
at least one memory; and
at least one processor coupled with the at least one memory and configured to cause the UE to:
receive data on an uplink bandwidth part (BWP), wherein the uplink BWP is configured for a time division duplex band, a downlink BWP is configured for the time division duplex band, and the uplink BWP is different from the downlink BWP.

13. The UE of claim 12, wherein a frequency of a common local oscillator (LO) is configured for the uplink BWP and the downlink BWP at a center of the uplink BWP.

14. The UE of claim 12, wherein a baseband transmit filter is configured such that the baseband transmit filter contains the uplink BWP and a bandwidth of the baseband transmit filter is less than a carrier bandwidth.

15. The UE of claim 14, wherein the bandwidth of the baseband transmit filter corresponds to a bandwidth of an allowed carrier bandwidth for a given frequency band.

16. The UE of claim 15, wherein the bandwidth of the baseband transmit filter corresponds to a bandwidth of a smallest allowed carrier bandwidth for the given frequency band larger than a bandwidth of the uplink BWP.

17. The UE of claim 15, wherein a maximum power reduction (MPR) allowed to meet emissions requirements is a reduced MPR relative to the MPR that is allowed if no BWP is configured for uplink.

18. The UE of claim 15, wherein a maximum power reduction (MPR) allowed to meet emissions constraints is the MPR allowed for a carrier bandwidth larger than a bandwidth of the uplink BWP but smaller than the configured carrier bandwidth.

19. A processor for wireless communication, comprising:
at least one controller coupled with at least one memory and configured to cause the processor to:
configure a downlink bandwidth part (BWP) for a time division duplex band; and
configure an uplink BWP for the time division duplex band, wherein the uplink BWP is different from the downlink BWP.

20. A processor for wireless communication, comprising:
at least one controller coupled with at least one memory and configured to cause the processor to:
receive data on an uplink bandwidth part (BWP), wherein the uplink BWP is configured for a time division duplex band, a downlink BWP is configured for the time division duplex band, and the uplink BWP is different from the downlink BWP.
